(19) United States
(12) Patent Application Publication
(10) Pub. No.: US 2018/0372912 A1
(43) Pub. Date: Dec. 27, 2018

(54) HIGH-RESOLUTION PRECIPITATION COMPENSATION SYSTEM AND METHOD

(71) Applicant: PUKYONG NATIONAL UNIVERSITY INDUSTRY-UNIVERSITY COOPERATION FOUNDATION, Busan (KR)

(72) Inventors: Jai-Ho Oh, Seoul (KR); Hong-Joong Kim, Gyeongsangnam-do (KR); Sin-ll Yang, Gyeongsangnam-do (KR); Hyung-Jeon Kang, Jeju-do (KR)

(21) Appl. No.: 16/063,241

(22) PCT Filed: Dec. 21, 2015
(86) PCT No.: PCT/KR2015/013996

§ 371 Date: Jun. 15, 2018

(30) Foreign Application Priority Data
Dec. 18, 2015 (KR) 10-2015-0182037

(51) Int. Cl. G01W 1/02; G01W 1/14; G06F 17/11

(52) U.S. Cl. CPC G01W 1/02; G06F 17/11; G01W 1/14

(57) ABSTRACT

The present disclosure relates to a high-resolution precipitation compensation system and method. More particularly, the present disclosure relates to a high-resolution precipitation compensation system and method in which reanalysis data are input as initial data to a high-resolution quantitative precipitation model (QPM), then weights are respectively applied to precipitation data derived from the QPM, radar echo precipitation data and satellite precipitation data, thereby to obtain resulting compensated precipitation data. According to the present disclosure, the reanalysis data is applied as initial data to the high-resolution quantitative precipitation model to obtain precipitation data with a resolution of 0.1 to 1.0 km and a relatively small error for the target region.

### CROSS-REFERENCE TO RELATED APPLICATION(S)

This application is the national phase of PCT Application No. PCT/KR2015/013996 filed Dec. 21, 2015, which in turn claims priority of Korean Application No. 10-2015-0182037 filed Dec. 18, 2015, each of which is incorporated herein by reference.

### TECHNICAL FIELD

The present disclosure relates to a high-resolution precipitation compensation system and method. More particularly, the present disclosure relates to a high-resolution precipitation compensation system and method in which reanalysis data are input as initial data to a high-resolution quantitative precipitation model (QPM), then weights are respectively applied to precipitation data derived from the QPM, radar echo precipitation data and satellite precipitation data, thereby to obtain resulting compensated precipitation data.

### BACKGROUND

Past map studies on urban floods, pests, and the like require very high-resolution weather data with a resolution of 0.1 to 1.0 km. The past map has AWS observed data. Thus, the map is studied using the AWS observed data. However, this observed data provides only weather data corresponding to observed points. The automatic weather system (AWS) based observed data are converted to high-resolution observed data using simple interpolation. The converted data are defined concentrically. Further, data corresponding to a specific region may be represented by a value of ‘0’. To solve this problem, a high-resolution data compensation method is required in which the AWS-based observed data is applied to the high-resolution quantitative precipitation model (QPM) to compensate for precipitation data with a resolution of 0.1 to 1.0 km for a target area, thereby to eliminate the phenomenon that data corresponding to the specific region is expressed as a value of ‘0’.

### SUMMARY

The present disclosure provides a system and method for compensating for precipitation data with a high-resolution of 0.1 to 1.0 km for the target region in an error-free manner using the high-resolution quantitative precipitation model.

In a first aspect, there is provided a high-resolution precipitation compensation system comprising: a data collection module configured for collecting reanalysis data, wherein the reanalysis data includes surface precipitation, upper atmospheric variable, and digital elevation model (DEM) elevation; a first precipitation compensation module configured for applying the surface precipitation, upper atmospheric variable, and digital elevation model (DEM) elevation to a high-resolution quantitative precipitation model (QPM) to obtain first compensated precipitation, wherein the surface precipitation, upper atmospheric variable, and digital elevation model (DEM) elevation are input as initial data to the high-resolution quantitative precipitation model; and a second precipitation compensation module configured for adding respective weights to the first compensated precipitation, radar echo precipitation, and satellite precipitation and summing the weighted first compensated precipitation, radar echo precipitation, and satellite precipitation, to obtain second or resulting compensated precipitation.

In one embodiment of the system, the system comprises a resolution adaptation module configured for adapting a resolution of the radar echo precipitation and a resolution of the satellite precipitation to a resolution of the first compensated precipitation.

In one embodiment of the system, the system comprises a data gridding module configured for gridding the surface precipitation, upper atmospheric variable, and digital elevation model (DEM) elevation using a Barnes objective analysis.

In one embodiment of the system, the data gridding module includes a weight calculation module, an initial estimate calculation module, and an analyzed value calculation module, wherein the weight calculation module is configured to calculate a weight based on a distance between a grid point and an adjacent observed point, wherein the initial estimate calculation module is configured to calculate an initial estimate at each grid point using the weight from the weight calculation module and an initial value at each observed point, wherein the analyzed value calculation module is configured to calculates a first analyzed value at a corresponding observed point by interpolation between initial estimates at grid points in an influence radius around the corresponding observed point, and to calculate a second analyzed value at a target grid point by adding a distance-based weight to a difference between the initial value at the observed point and the first analyzed value and by adding the weighted difference to the initial estimate at the target grid point.

In one embodiment of the system, the weight calculation module is configured to calculate the weight using a following equation:

Wₖ=e^{-(d/R)}^{²}

where R indicates the influence radius, d indicates a distance between the grid point and observed point, and k indicates the observed point in the influence radius.

In one embodiment of the system, the initial estimate calculation module is configured to calculate the initial estimate (I_{g}) at each grid point using a following equation:

$${I}_{g} = \frac{{\sum }_{k = 1}^{N} {W}_{k} {I}_{k}}{{\sum }_{k = 1}^{N} {W}_{k}}$$

where Iₖ indicates the initial estimate at a corresponding observed point k, g indicates a corresponding grid point, and n indicates a number of all of observed points.

In one embodiment of the system, the analyzed value calculation module is configured to calculate the second analyzed value at the target grid point using a following equation:

$${A}_{g} = {I}_{g} + \frac{{\sum }_{k = 1}^{N} {W}_{k}^{′} ( {I}_{k} - {A}_{k} )}{{\sum }_{k = 1}^{N} {W}_{k}^{′}}$$

where A_{g} indicates the second analyzed value at the target grid point g, Aₖ indicates the first analyzed value Aₖ at the corresponding observed point k, wherein W′ₖ indicates the distance-based weight as follows W′ₖ=e^{-(d/RΓ)}^{²}, wherein Γ is a value between 0 and 1.

In one embodiment of the system, the system includes a geopotential calculation module configured for calculating a geopotential, wherein the geopotentialis calculated using an equation Ψ=∫₀^{z}gdz, wherein g (ms⁻²) is 9.81 when z (km) is 0 and Z (km)=0; g (ms⁻²) is 9.80 when z (km) is 1 and Z (km)=1.00; g (ms⁻²) is 9.77 when z (km) is 10 and Z (km)=9.99; g (ms⁻²) is 9.50 when z (km) is 100 and Z (km)=98.47; or g (ms⁻²) is 8.43 when z (km) is 500 and Z (km)=463.6.

In one embodiment of the system, the system includes a vertical velocity calculation module configured to calculate a vertical velocity, wherein the vertical velocity is calculated using an equation ω=dp/dt.

In one embodiment of the system, the first precipitation compensation module is configured to input automatic weather system (AWS)-based data to the high-resolution quantitative precipitation model (QPM) as initial data thereto to obtain first compensated precipitation, wherein the automatic weather system (AWS)-based data input to the QPM has been gridded in a binary format.

In a second aspect, there is provided a high-resolution precipitation compensation method comprising: collecting reanalysis data by a data collection module, wherein the reanalysis data includes surface precipitation, upper atmospheric variable, and digital elevation model (DEM) elevation; applying, by a first precipitation compensation module, the surface precipitation, upper atmospheric variable, and digital elevation model (DEM) elevation to a high-resolution quantitative precipitation model (QPM) to obtain first compensated precipitation, wherein the surface precipitation, upper atmospheric variable, and digital elevation model (DEM) elevation are input as initial data to the high-resolution quantitative precipitation model; and adding, by a second precipitation compensation module, respective weights to the first compensated precipitation, radar echo precipitation, and satellite precipitation and summing, by the second module, the weighted first compensated precipitation, radar echo precipitation, and satellite precipitation, to obtain second or resulting compensated precipitation.

In one embodiment of the method, the method further comprises adapting, by a resolution adaptation module, a resolution of the radar echo precipitation and a resolution of the satellite precipitation to a resolution of the first compensated precipitation. In one embodiment of the method, the method further comprises gridding, by a data gridding module, the surface precipitation, upper atmospheric variable, and digital elevation model (DEM) elevation using a Barnes objective analysis.

In one embodiment of the method, the second compensated precipitation (R) is obtained based on a following equation:

Rᵢⱼ=ω₁QRᵢⱼ+ω₂SRᵢⱼ+ω₃RRᵢⱼ

where R indicates the second or resulting compensated precipitation, w₁ indicates a weight for QR, w₂ indicates a weight for SR, w₃ indicates a weight for RR, wherein QR indicates the first compensated precipitation, SR indicates the satellite precipitation, RR indicates the radar echo precipitation, I indicates a latitude, and j indicates a longitude. In one embodiment of the method, w₁+w₂+w₃=1, wherein all of the first compensated precipitation, the satellite precipitation and the radar echo precipitation are available, w₁=w₂=w₃=1/3,
wherein when one of the first compensated precipitation, the satellite precipitation and the radar echo precipitation is non-available, the weight correspond to the non-available precipitation is zero.

In one embodiment of the method, wherein gridding using the Barnes objective analysis includes: calculating, by a weight calculation module, a weight based on a distance between a grid point and an adjacent observed point, calculating, by an initial estimate calculation module, an initial estimate at each grid point using the weight from the weight calculation module and an initial value at each observed point, calculating, by an analyzed value calculation module, a first analyzed value at a corresponding observed point by interpolation between initial estimates at grid points in an influence radius around the corresponding observed point, and calculating, by the analyzed value calculation module, a second analyzed value at a target grid point by adding a distance-based weight to a difference between the initial value at the observed point and the first analyzed value and by adding the weighted difference to the initial estimate at the target grid point.

In one embodiment of the method, the method includes calculating a geopotential by a geopotential calculation module, wherein the geopotentialis calculated using an equation Ψ=∫₀^{z}gdz, wherein g (ms⁻²) is 9.81 when z (km) is 0 and Z (km)=0; g (ms⁻²) is 9.80 when z (km) is 1 and Z (km)=1.00; g (ms⁻²) is 9.77 when z (km) is 10 and Z (km)=9.99; g (ms⁻²) is 9.50 when z (km) is 100 and Z (km)=98.47; or g (ms⁻²) is 8.43 when z (km) is 500 and Z (km)=463.6.

In one embodiment of the method, the method includes calculating a vertical velocity by a vertical velocity calculation module, wherein the vertical velocity is calculated using an equation ω=dp/dt.

In one embodiment of the method, the method further includes inputting, by the first precipitation compensation module, automatic weather system (AWS)-based data to the high-resolution quantitative precipitation model (QPM) as initial data thereto to obtain first compensated precipitation, wherein the automatic weather system (AWS)-based data input to the QPM has been gridded in a binary format.

According to the present disclosure, the reanalysis data is applied as initial data to the high-resolution quantitative precipitation model to obtain precipitation data with a resolution of 0.1 to 1.0 km and a relatively small error for the target region.

Further, in accordance with the present disclosure, weights are respectively added to the first precipitation data derived from the high-resolution quantitative precipitation model, the radar echo precipitation data and the satellite precipitation data, to calculate the second resulting compensated precipitation data. This may accurately compensate for past precipitation.

### BRIEF DESCRIPTION OF THE DRAWINGS

FIG. 1 is a block diagram of a high-resolution precipitation compensation system according to the present disclosure.

FIG. 2 is a diagram for illustrating data gridding in a high-resolution precipitation compensation system according to the present disclosure.

FIG. 3 is a flowchart of a high-resolution precipitation data compensation method according to the present disclosure.

### DETAILED DESCRIPTION

Hereinafter, embodiments of the present disclosure will be described in detail with reference to the drawings.

However, the present disclosure is not limited to the embodiments disclosed below, but may be implemented in various different forms. These embodiments are provided so that the present disclosure is complete, and that they fully convey the scope of the invention to those of ordinary skill in the art. Like numbers refer to like elements throughout the drawings.

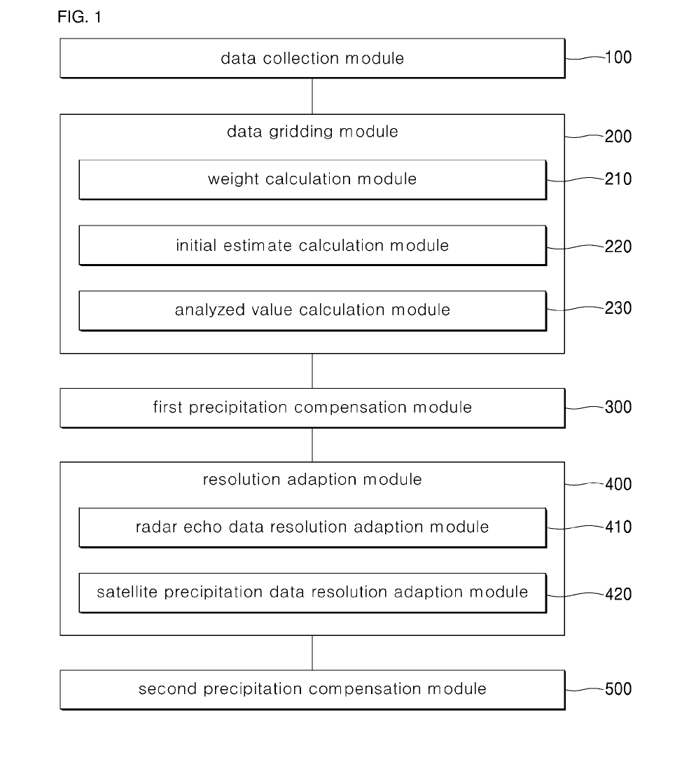

FIG. 1 is a block diagram of a high-resolution precipitation compensation system according to the present disclosure.

The high-resolution precipitation compensation system according to the present disclosure, as shown in FIG. 1 includes a data collection module 100 configured for collecting reanalysis data, radar echo precipitation data and satellite precipitation data; a data gridding module 200 configured for gridding the reanalysis data, wherein the reanalysis data is irregular; a first precipitation compensation module 300 configured for applying the gridded reanalysis data to a high-resolution quantitative precipitation model to obtain first compensated precipitation data, wherein the gridded reanalysis data is input as an initial data to the high-resolution quantitative precipitation model; a resolution adaptation module 400 configured for adapting a resolution of the radar echo precipitation data and a resolution of the satellite precipitation data to a resolution of the first compensated precipitation data; and a second precipitation compensation module 500 configured for adding respective weights to the first compensated precipitation data, radar echo precipitation data, and satellite precipitation data to obtain second compensated precipitation data.

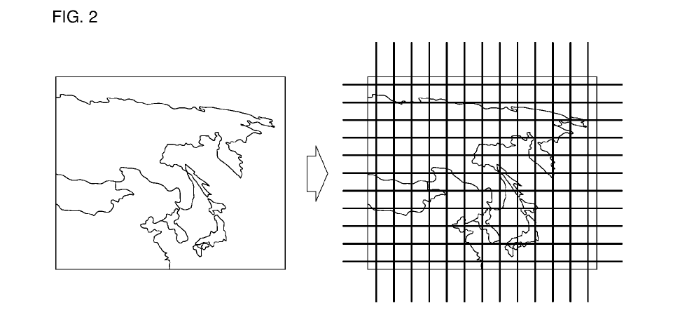

FIG. 2 is a diagram for illustrating data gridding in the high-resolution precipitation compensation system according to the present disclosure.

The data collection module 100 includes a reanalysis data collection module for collecting the reanalysis data including surface precipitation data to be compensated, radar echo data collection module for collecting radar echo data, satellite precipitation data collection module for collecting satellite precipitation data. In this connection, the reanalysis data collected from the reanalysis data collection module includes surface precipitation, upper atmospheric variable, and DEM elevation data. Further, the upper atmospheric variables include relative humidity, geopotential height, east-west flow, north-south flow, vertical velocity and temperature.

The data gridding module 200 grids the irregularly formed reanalysis data to be adapted for the high-resolution quantitative precipitation model. According to the present disclosure, interpolation for the gridding adopts Barnes 1964 objective analysis. The Barnes objective method adds a weight based on a distance from a grid point to a value corresponding to an observed point around the grid point. As a result, values corresponding to uniformly-distributed grid points are calculated from values corresponding to irregularly-distributed observed points. Further, to this end, the data gridding module 200 includes a weight calculation module 210, an initial estimate calculation module 220 and an analyzed value calculation module 230.

The weight calculation module 210 obtains a weight based on a distance between a given grid point and an observed point around the grid point. The weight calculation module 210 obtains the weight W as follows:

Wₖ=e^{-(d/R)}^{²} [Equation 1]

where R indicates an influence radius, d indicates a distance between the grid point and observed point, and k indicates the observed point in the influence radius.

After the weight calculation module 210 determines the weight based on the distance between the grid point and the observed point in the influence radius, the initial estimate calculation module 220 uses an initial value Iₖ at each observed point k to calculate an initial estimate I_{g} at each grid point g, as expressed in Equation 2 below:

$${I}_{g} = \frac{{\sum }_{k = 1}^{N} {W}_{k} {I}_{k}}{{\sum }_{k = 1}^{N} {W}_{k}} \qquad [ Equation 2 ]$$

In the above equation 2, n indicates a number of all of observed points.

Next, the analyzed value calculation module 230 calculates a first analyzed value Aₖ at a corresponding observed point k by interpolation between initial estimates I_{g} at grid points g in the influence radius R around the corresponding observed point k using the above Equation 2. Then, a distance-based weight W′ₖ is added to a difference between the initial value Iₖ at the observed point k and the first analyzed value Aₖ, to obtain a result value. Then, the initial estimate I_{g} obtained in the Equation 2 is added to the resultant value. Thus, a second analyzed value A_{g} at the target grid point g is obtained. This is expressed in Equation 3 below.

$${A}_{g} = {I}_{g} + \frac{{\sum }_{k = 1}^{N} {W}_{k}^{′} ( {I}_{k} - {A}_{k} )}{{\sum }_{k = 1}^{N} {W}_{k}^{′}} \qquad [ Equation 3 ]$$

In this connection, the distance-based weight W′ₖ is calculated from below Equation 4:

W′ₖ=e^{-(d/RΓ)}^{²} [Equation 4]

In the above Equation 4, Γ is a value between 0 and 1.

In this connection, the resolution is preferably 10 km, taking into account an average distance between AWS observation station distributions.

The data required for the high-resolution quantitative precipitation model (QPM) are shown in Table 1.

TABLE 1

| | Components [unit] |
|---|---|
| 1 | Total precipitation [kg/m²] |
| 2 | Zonal wind [m/s] |
| 3 | Meridional wind [m/s] |
| 4 | Geopotential [m²/s²] |
| 5 | Temperature [K] |
| 6 | Vertical velocity ω = dp/dt [Pa/s] |
| 7 | Relative humidity [%] |

The AWS based observed data does not include the geopotential and the vertical velocity. The geopotential and vertical velocity are obtained using following formulae respectively: Ψ=∫₀^{z}gdz, ω=dp/dt. Accordingly, the system according to the present disclosure further comprises a geopotential calculation module for calculating the geopotential and a vertical velocity calculation module for calculating the vertical velocity. Further, g is as follows in a below Table 2:

TABLE 2

| z (km) | Z (km) | g (ms⁻²) |
|---|---|---|
| 0 | 0 | 9.81 |
| 1 | 1.00 | 9.80 |
| 10 | 9.99 | 9.77 |
| 100 | 98.47 | 9.50 |
| 500 | 463.6 | 8.43 |

A format of the gridded AWS-based data takes a binary format so that the data is suitable for the high-resolution quantitative precipitation mode.

The first precipitation compensation module 300 applies the gridded AWS-based data having the binary format as initial data to the high-resolution quantitative precipitation model to obtain first compensated precipitation data.

The resolution adaptation module 400 adapts resolutions of the radar echo data and satellite precipitation data to a resolution of the first compensated (surface) precipitation data. To this end, the resolution adaptation module 400 includes a radar echo data resolution adaptation module 410 configured to adapt the resolution of the radar echo data, and a satellite precipitation data resolution adaptation module 420 configured to adapt the resolution of the satellite precipitation data.

The second precipitation compensation module 500 adds respective weights to the radar echo data, satellite data, and first compensated precipitation data to obtain resulting or second compensated precipitation data. In this connection, the resulting compensated precipitation data R may be obtained based on a following Equation 5:

Rᵢⱼ=ω₁QRᵢⱼ+ω₂SRᵢⱼ+ω₃RRᵢⱼ [Equation 5]

In the above Equation 5, R indicates resulting compensated precipitation data, wₙ indicates the respective weight. Further, a sum of the weights is equal to w₁+w₂+w₃=1. QR denotes precipitation data as surface precipitation as compensated from the first precipitation compensation module 200. SR indicates the satellite precipitation, RR indicates the radar echo precipitation, i means a latitude, and j means a longitude.

Further, an observation point that overlaps with a grid point corresponding to the resulting compensated precipitation data is selected. The precipitation corresponding to the selected observation point is compared with the precipitation corresponding to the grid point. Then, the weight is determined such that a difference between them becomes the smallest.

Of course, the compensated precipitation data considering the surface precipitation compensated by the first precipitation compensation module 200, and the satellite precipitation and radar echo precipitation data are generated by different methods. Thus, an equal weight is applied to each of the precipitation data, satellite precipitation and radar echo precipitation. In this case, the w₁=w₂=w₃=1/3. Further, when one of the precipitation data as surface precipitation compensated by the first precipitation compensation module 200, and the satellite precipitation and the radar echo precipitation is not available, a weight corresponding to the non-available data is zero. For example, when the radar echo precipitation is not available, w₁=w₂=0.5, w₃=0. When both of the satellite precipitation and radar echo precipitation are not available, w₁=1, w₂=0, w₃=0.

As described above, according to the present disclosure, the AWS-based observed data with the irregularity may be applied as initial data to the high-resolution quantitative precipitation model to compensate for the AWS observed data. As a result, using the high-resolution quantitative precipitation model, the precipitation data with 0.1 to 1.0 km resolution and a relatively small error for the target region may be supplied to a past map detailed precipitation compensation system. Further, in accordance with the present disclosure, rather than using predicted values from the weather model as initial data for the high-resolution quantitative precipitation model with a high sensitivity to initial data, values at points where there are no observation stations may be calculated while maintaining values at the points where the stations are located. Further, the compensated precipitation data may be used to study various past maps, such as past urban floods and pest maps.

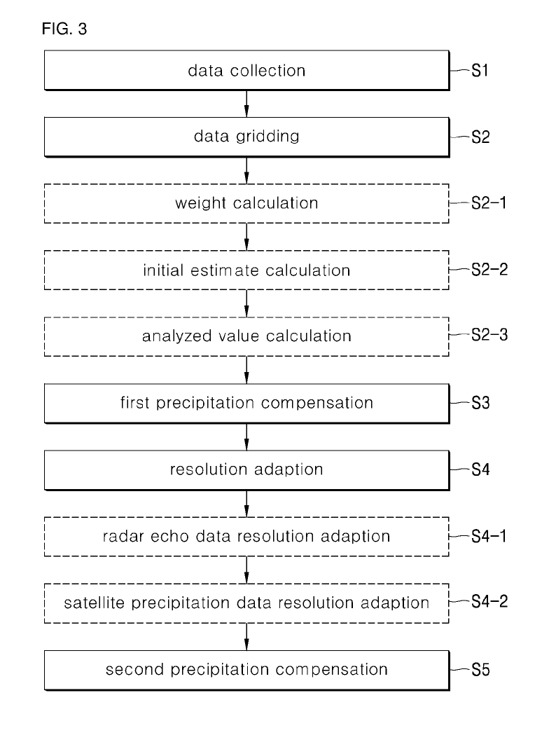

Hereinafter, a high-resolution precipitation data compensation method according to the present disclosure will be described with reference to FIG. 3. Overlapping descriptions with the above descriptions regarding the high-resolution precipitation compensation system are omitted or simplified.

FIG. 3 is a flowchart of a high-resolution precipitation data compensation method according to the present disclosure.

The high-resolution precipitation data compensation method according to the present disclosure includes an operation S1 for collecting data, a gridding operation S2 for gridding irregular data, a first precipitation data compensation operation S3 for compensating for precipitation data using the gridded data as an input value, a resolution adaptation operation S4, and a second precipitation data compensation operation S5.

In the operation S1 for collecting data, the data collection module collects the reanalysis data, radar echo data, and satellite precipitation data to compensate for surface precipitation data. In this connection, the reanalysis data includes surface precipitation of the reanalysis data, upper atmospheric variables of the reanalysis data, and DEM elevation data, as described above.

In the gridding operation S2, the data gridding module 200 grids the irregularly formed reanalysis data or AWS-based data to be adapted for the high-resolution quantitative precipitation model. According to the present disclosure, interpolation for the gridding adopts Barnes 1964 objective analysis. The operation S2 includes weight calculation operation S2-1, initial estimate calculation operation S2-2, and analyzed value calculation operation S2-3.

In the operation S2-1, the weight calculation module is configured to calculate a weight based on a distance between a grid point and an adjacent observed point. The operation S2-1 may be executed using the above equation 1.

In the operation S2-2, the initial estimate calculation module is configured to calculate an initial estimate I_{g} at each grid point g using the weight resulting from the weight calculation operation S2-1 and an initial value Iₖ at each observed point k.

In the operation S2-3, the analyzed value calculation module is configured to calculates a first analyzed value Aₖ at a corresponding observed point k by interpolation between initial estimates I_{g} at grid points g in an influence radius R around the corresponding observed point k, and to calculate a second analyzed value A_{g} at a target grid point g by adding a distance-based weight W′ₖ to a difference between the initial value at the observed point and the first analyzed value and by adding the weighted difference to the initial estimate at the target grid point.

Further, as mentioned above, the AWS based observed data does not include the geopotential and the vertical velocity. Thus, the method includes calculating a geopotential by a geopotential calculation module, wherein the geopotentialis calculated using an equation Ψ=∫₀^{z}gdz. The method includes calculating a vertical velocity by a vertical velocity calculation module, wherein the vertical velocity is calculated using an equation ω=dp/dt.

The first precipitation data compensation operation S3 further includes inputting, by the first precipitation compensation module, automatic weather system (AWS)-based data to the high-resolution quantitative precipitation model (QPM) as initial data thereto to obtain first compensated precipitation, wherein the automatic weather system (AWS)-based data input to the QPM has been gridded in a binary format.

In the resolution adaptation operation S4, the resolution adaptation module may adapt a resolution of the radar echo precipitation and a resolution of the satellite precipitation to a resolution of the first compensated precipitation (resulting from the operation S3).

In the second precipitation data compensation operation S5, the second precipitation compensation module receives the radar echo precipitation and the satellite precipitation with the adapted resolutions (resulting from the operation S4). Then, the second precipitation compensation module adds respective weights to the first compensated precipitation, radar echo precipitation, and satellite precipitation and sums the weighted first compensated precipitation, radar echo precipitation, and satellite precipitation, to obtain the second or resulting compensated precipitation.

According to the present disclosure, the reanalysis data is applied as initial data to the high-resolution quantitative precipitation model to obtain precipitation data with a resolution of 0.1 to 1.0 km and a relatively small error for the target region. Further, in accordance with the present disclosure, weights are respectively added to the first precipitation data derived from the high-resolution quantitative precipitation model, the radar echo precipitation data and the satellite precipitation data, to calculate the second resulting compensated precipitation data. This may accurately compensate for past precipitation.

It will be appreciated by those skilled in the art that while the present invention has been particularly shown and described with reference to exemplary embodiments thereof, various modifications and variations may be made to the present disclosure without departing from the spirit of the present disclosure set forth in the following claims.

1. A high-resolution precipitation compensation system comprising:
a data collection module configured for collecting reanalysis data, wherein the reanalysis data includes surface precipitation, upper atmospheric variable, and digital elevation model (DEM) elevation;
a first precipitation compensation module configured for applying the surface precipitation, upper atmospheric variable, and digital elevation model (DEM) elevation to a high-resolution quantitative precipitation model (QPM) to obtain first compensated precipitation, wherein the surface precipitation, upper atmospheric variable, and digital elevation model (DEM) elevation are input as initial data to the high-resolution quantitative precipitation model; and
a second precipitation compensation module configured for adding respective weights to the first compensated precipitation, radar echo precipitation, and satellite precipitation and summing the weighted first compensated precipitation, radar echo precipitation, and satellite precipitation, to obtain second resulting compensated precipitation.

2. The system of claim 1, further comprising a resolution adaptation module configured for adapting a resolution of the radar echo precipitation and a resolution of the satellite precipitation to a resolution of the first compensated precipitation.

3. The system of claim 2, wherein the second compensated precipitation (R) is obtained based on a following equation:
Rᵢⱼ=ω₁QRᵢⱼ+ω₂SRᵢⱼ+ω₃RRᵢⱼ,
where R indicates the second resulting compensated precipitation, w₁ indicates a weight for QR, w₂ indicates a weight for SR, w₃ indicates a weight for RR, wherein QR indicates the first compensated precipitation, SR indicates the satellite precipitation, RR indicates the radar echo precipitation, i indicates a latitude, and j indicates a longitude.

4. The system of claim 3, wherein w₁+w₂+w₃=1,
wherein when all of the first compensated precipitation, the satellite precipitation and the radar echo precipitation are available, w₁=w₂=w₃=1/3, and
wherein when one of the first compensated precipitation, the satellite precipitation and the radar echo precipitation is non-available, the weight corresponding to the non-available precipitation is zero.

5. The system of claim 4, further comprising a data gridding module configured for gridding the surface precipitation, upper atmospheric variable, and digital elevation model (DEM) elevation using a Barnes objective analysis.

6. The system of claim 5, wherein the data gridding module includes a weight calculation module, an initial estimate calculation module, and an analyzed value calculation module,
wherein the weight calculation module is configured to calculate a weight based on a distance between a grid point and an adjacent observed point,
wherein the initial estimate calculation module is configured to calculate an initial estimate at each grid point using the weight from the weight calculation module and an initial value at each observed point, and
wherein the analyzed value calculation module is configured to calculate a first analyzed value at a corresponding observed point by interpolation between initial estimates at grid points in an influence radius around the corresponding observed point, and to calculate a second analyzed value at a target grid point by adding a distance-based weight to a difference between the initial value at the observed point and the first analyzed value and by adding the resulting weighted difference to the initial estimate at the target grid point.

7. The system of claim 6, wherein the weight calculation module is configured to calculate the weight using a following equation:
Wₖ=e^{(d/R)}^{²}
where R indicates the influence radius, d indicates a distance between the grid point and observed point, and k indicates the observed point in the influence radius.

8. The system of claim 7, wherein the initial estimate calculation module is configured to calculate the initial estimate (I_{g}) at each grid point using a following equation:
$${I}_{g} = \frac{{\sum }_{k = 1}^{N} {W}_{k} {I}_{k}}{{\sum }_{k = 1}^{N} {W}_{k}}$$
where Iₖ indicates the initial estimate at a corresponding observed point k, g indicate a corresponding grid point, and n indicates a number of all of observed points.

9. The system of claim 8, wherein the analyzed value calculation module is configured to calculate the second analyzed value at the target grid point using a following equation:
$${A}_{g} = {I}_{g} + \frac{{\sum }_{k = 1}^{N} {W}_{k}^{′} ( {I}_{k} - {A}_{k} )}{{\sum }_{k = 1}^{N} {W}_{k}^{′}}$$
where A_{g} indicates the second analyzed value at the target grid point g, Aₖ indicates the first analyzed value Aₖ at the corresponding observed point k,
wherein W′ₖ indicate the distance-based weight as follows: W′ₖ=e^{(d/RΓ)}^{²},
wherein Γ is a value between 0 and 1.

10. The system of claim 9, wherein the system includes a geopotential calculation module configured for calculating a geopotential, wherein the geopotential is calculated using an equation Ψ=∫₀^{z}gdz,
wherein g(ms⁻²) is 9.81 when z(km) is 0 and Z(km)=0; g(ms⁻²) is 9.80 when z(km) is 1 and Z(km)=1.00; g(ms⁻²) is 9.77 when z(km) is 10 and Z(km)=9.99; g(ms⁻²) is 9.50 when z(km) is 100 and Z(km)=98.47; or g(ms⁻²) is 8.43 when z(km) is 500 and Z(km)=463.6.

11. The system of claim 10, wherein the system includes a vertical velocity calculation module configured to calculate a vertical velocity, wherein the vertical velocity is calculated using an equation ω=dp/dt.

12. The system of claim 11, wherein the first precipitation compensation module is configured to input automatic weather system (AWS)-based data to the high-resolution quantitative precipitation model (QPM) as initial data thereto to obtain first compensated precipitation, wherein the automatic weather system (AWS)-based data input to the QPM has been gridded in a binary format.

13. A high-resolution precipitation compensation method comprising:
collecting reanalysis data by a data collection module, wherein the reanalysis data includes surface precipitation, upper atmospheric variable, and digital elevation model (DEM) elevation;
applying, by a first precipitation compensation module, the surface precipitation, upper atmospheric variable, and digital elevation model (DEM) elevation to a high-resolution quantitative precipitation model (QPM) to obtain first compensated precipitation, wherein the surface precipitation, upper atmospheric variable, and digital elevation model (DEM) elevation are input as initial data to the high-resolution quantitative precipitation model; and
adding, by a second precipitation compensation module, respective weights to the first compensated precipitation, radar echo precipitation, and satellite precipitation and summing, by the second module, the weighted first compensated precipitation, radar echo precipitation, and satellite precipitation, to obtain second resulting compensated precipitation.

14. The method of claim 13, further comprising adapting, by a resolution adaptation module, a resolution of the radar echo precipitation and a resolution of the satellite precipitation to a resolution of the first compensated precipitation.

15. The method of claim 14, wherein the second compensated precipitation (R) is obtained based on a following equation:
Rᵢⱼ=ω₁QRᵢⱼ+ω₂SRᵢⱼ+ω₃RRᵢⱼ,
where R indicates the second resulting compensated precipitation, w₁ indicates a weight for QR, w₂ indicates a weight for SR, w₃ indicates a weight for RR, wherein QR indicates the first compensated precipitation, SR indicates the satellite precipitation, RR indicates the radar echo precipitation, i indicates a latitude, and j indicates a longitude.

16. The method of claim 15, wherein w₁+w₂+w₃=1,
wherein when all of the first compensated precipitation, the satellite precipitation and the radar echo precipitation are available, w₁=w₂=w₃=1/3, and
wherein when one of the first compensated precipitation, the satellite precipitation and the radar echo precipitation is non-available, the weight correspond to the non-available precipitation is zero.

17. The method of claim 16, further comprising gridding, by a data gridding module, the surface precipitation, upper atmospheric variable, and digital elevation model (DEM) elevation using a Barnes objective analysis.

18. The method of claim 17, wherein gridding using the Barnes objective analysis includes:
calculating, by a weight calculation module, a weight based on a distance between a grid point and an adjacent observed point,
calculating, by an initial estimate calculation module, an initial estimate at each grid point using the weight from the weight calculation module and an initial value at each observed point,
calculating, by an analyzed value calculation module, a first analyzed value at a corresponding observed point by interpolation between initial estimates at grid points in an influence radius around the corresponding observed point, and
calculating, by the analyzed value calculation module, a second analyzed value at a target grid point by adding a distance-based weight to a difference between the initial value at the observed point and the first analyzed value and by adding the resulting weighted difference to the initial estimate at the target grid point.

19. The method of claim 18, wherein the weight is calculated by the weight calculation module using a following equation:
Wₖ=e^{-(d/R)}^{²}
where R indicates the influence radius, d indicates a distance between the grid point and observed point, and k indicates the observed point in the influence radius.

20. The method of claim 19, wherein the initial estimate (I_{g}) at each grid point is calculated by the initial estimate calculation module using a following equation:
$${I}_{g} = \frac{{\sum }_{k = 1}^{N} {W}_{k} {I}_{k}}{{\sum }_{k = 1}^{N} {W}_{k}}$$
where Iₖ indicates the initial estimate at a corresponding observed point k, g indicate a corresponding grid point, and n indicates a number of all of observed points.

21. The method of claim 20, wherein the second analyzed value at the target grid point is calculated by the analyzed value calculation module using a following equation:
$${A}_{g} = {I}_{g} + \frac{{\sum }_{k = 1}^{N} {W}_{k}^{′} ( {I}_{k} - {A}_{k} )}{{\sum }_{k = 1}^{N} {W}_{k}^{′}}$$
where A_{g} indicates the second analyzed value at the target grid point g, Aₖ indicates the first analyzed value Aₖ at the corresponding observed point k,
wherein W′ₖ indicate the distance-based weight as follows: W′ₖ=e^{-(d/RΓ)}^{²},
wherein Γ is a value between 0 and 1.

22. The method of claim 20, wherein the method includes calculating a geopotential by a geopotential calculation module, wherein the geopotential is calculated using an equation Ψ=∫₀^{z} gdz,
wherein g(ms⁻²) is 9.81 when z(km) is 0 and Z(km)=0; g(ms⁻²) is 9.80 when z(km) is 1 and Z(km)=1.00; g(ms⁻²) is 9.77 when z(km) is 10 and Z(km)=9.99; g(ms⁻²) is 9.50 when z(km) is 100 and Z(km)=98.47; or g(ms⁻²) is 8.43 when z(km) is 500 and Z(km)=463.6.

23. The method of claim 22, wherein the method includes calculating a vertical velocity by a vertical velocity calculation module, wherein the vertical velocity is calculated using an equation ω=dp/dt.

24. The method of claim 23, wherein the method further includes inputting, by the first precipitation compensation module, automatic weather system (AWS)-based data to the high-resolution quantitative precipitation model (QPM) as initial data thereto to obtain first compensated precipitation, wherein the automatic weather system (AWS)-based data input to the QPM has been gridded in a binary format.
